(19) United States
(12) Patent Application Publication
(10) Pub. No.: US 2003/0222792 A1
(43) Pub. Date: Dec. 4, 2003

(54) Method, system and storage medium for monitoring parking meters

(76) Inventors: Larry Berman, Delray, FL (US); Arthur R. Truckenbrodt, Orient, NY (US)

Correspondence Address: Michael A. Cantor, Cantor Colburn LLP, 55 Griffin Road South, Bloomfield, CT, 06002, US

(21) Appl. No.: 10/158,493

(22) Filed: May 30, 2002

(51) Int. Cl. G08G 1/14

(52) U.S. Cl. 340/932.2; 705/13; 235/378; 235/384; 340/5.1

(57) ABSTRACT

A method for monitoring parking meters. The method comprises selecting a route. The route includes a parking meter identifier. An employee is selected to monitor the route. A meter RFID tag that is affixed to a parking meter that corresponds to the parking meter identifier is scanned, where the scanning is performed using a RFID reader that includes memory and the meter RFID tag includes a first unique serial number. The first unique serial number and a first date/time stamp are stored in the memory. An incident code is selected in response to determining that the parking meter needs repair. A status code is selected in response to selecting an incident code and to a current status of the parking meter. The contents of the memory are transmitted to a host system.

### BACKGROUND OF THE INVENTION

The present disclosure relates generally to a method for monitoring parking meters and in particular, to a method for using radio frequency identification (RFID) for information management relating to monitoring parking meters, including maintenance, collection and enforcement.

A typical parking meter is mounted on a metal stanchion or post and located on a street or parking lot in proximity to one or more parking spaces. The parking meter consists of a housing that will typically have an upper housing portion that is used for enclosing a parking meter mechanism. A parking meter can regulate one parking space or a multi-space parking meter can regulate multiple parking spaces. The parking meter mechanism includes means for accepting payment, recording the time purchased and displaying the parking time remaining. In some cases the parking meter mechanism also issues a receipt. Typically, parking meters are monitored for repair and replacement on a regular basis. Some repairs are due to expected events (e.g., battery replacement) and others are due to unexpected events (e.g., vandalism, car accidents). One way to monitor the maintenance status of a parking meter is to use infrared (IR) communications to identify the specific parking meter and then track maintenance issues with the use of a handheld device. The problem with using IR is that in the past, individuals have been able to manipulate the IR communications with external devices that are readily available (e.g., television remote controls). In addition, IR is not always reliable on rainy or very sunny days. This can result in maintenance records that are not accurate, and create problems when enforcing parking tickets and fines.

### BRIEF DESCRIPTION OF THE INVENTION

An embodiment of the invention is a method for monitoring parking meters. The method comprises selecting a route. The route includes a parking meter identifier. An employee is selected to monitor the route. A meter RFID tag that is affixed to a parking meter that corresponds to the parking meter identifier is scanned, where the scanning is performed using a RFID reader that includes memory and the meter RFID tag includes a first unique serial number. The first unique serial number and a first date/time stamp are stored in the memory. An incident code is selected in response to determining that the parking meter needs repair. A status code is selected in response to selecting an incident code and to a current status of the parking meter. The contents of the memory are transmitted to a host system. Additional embodiments include a system and storage medium for monitoring parking meters.

Further aspects of the invention are disclosed herein. The above discussed and other features and advantages of the present invention will be appreciated and understood by those skilled in the art from the following detailed description and drawings.

### BRIEF DESCRIPTION OF THE DRAWINGS

Referring to the exemplary drawings wherein like elements are numbered alike in the several Figures:

FIG. 1 is a block diagram of an exemplary system for monitoring the maintenance status of parking meters;

FIG. 2 is a block diagram of an exemplary process for monitoring maintenance of parking meters;

FIG. 3 is an exemplary embodiment of an external route menu;

FIG. 4 is an exemplary embodiment of an external incident menu;

FIG. 5 is an exemplary user interface for the maintenance monitoring application; and

FIG. 6 is a block diagram of an exemplary process for performing the maintenance monitoring application reporting.

### DETAILED DESCRIPTION OF THE INVENTION

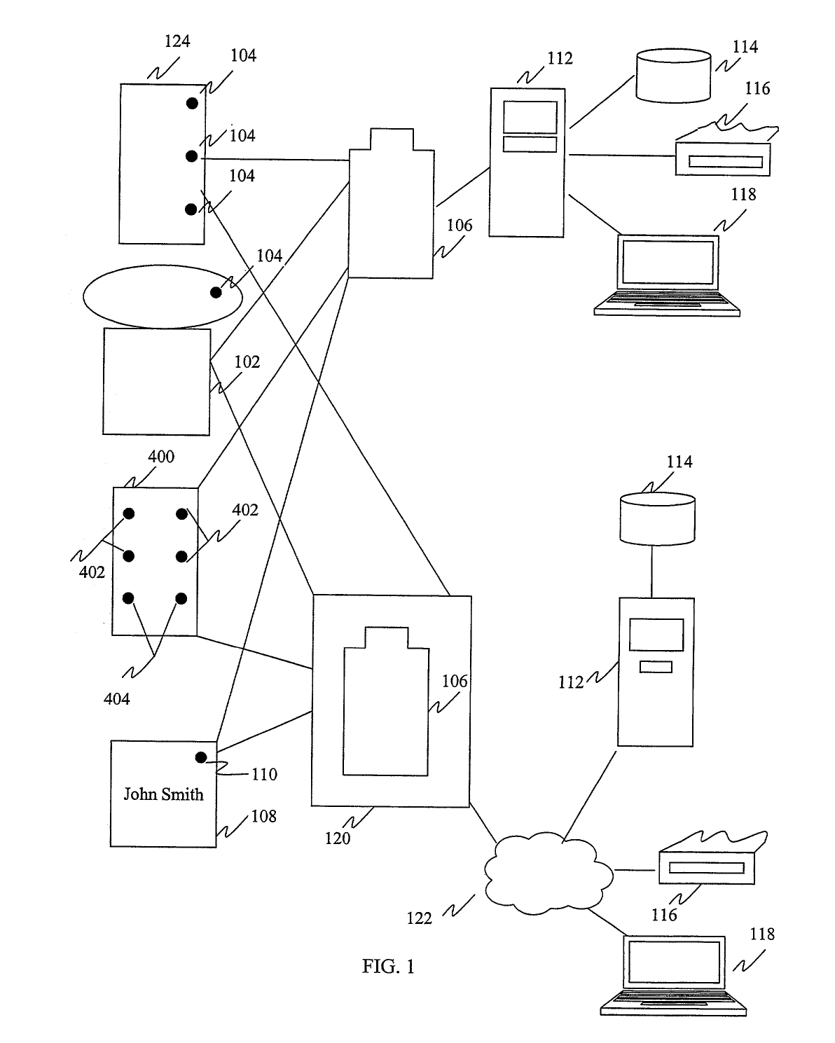

An embodiment of the present invention allows for monitoring the maintenance status of parking meters using radio frequency identification (RFID) readers and tags. FIG. 1 is a block diagram of an exemplary system for monitoring the maintenance status of parking meters. The system includes a parking meter 102 with a RFID tag 104. In an exemplary embodiment, the system includes a plurality of parking meters 102 with RFID tags 104. Also shown in FIG. 1 is a multi-space parking meter 124 with RFID tags 104. In an exemplary embodiment, any combination of single space parking meters 102 and multi-space parking meters 124 can be implemented. In embodiments where parking meter 102 is referred to in this application, one or more multi-space parking meters 124 can be substituted or added. In an exemplary embodiment, the RFID tag 104 is located in the upper housing of the parking meter 102 in the meter dome. Alternatively, the RFID tag 104 could be placed on the meter, the dome, the housing or the rate plate. The RFID tag 104 is affixed to the dome in a location where it will not interfere with the meter operation or view of the LED or LCD displays in the parking meter 102. The RFID tag 104 is assigned a unique serial number that is written to the RFID tag 104 during manufacture and cannot be changed. An exemplary RFID tag 104 is circular in shape, approximately one half of an inch in diameter and affixed to the parking meter 102 using high bond tape. Other RFID tag 104 shapes, sizes and methods of affixing to the parking meter 102 can be used in alternate embodiments of the present invention.

As shown in FIG. 1, a handheld RFID reader 106 is used to scan the RFID tag 104. The RFID reader 106 logs in its memory the serial number of the RFID tag 104 that was scanned, along with a date/time stamp. Any RFID reader 106 known in the art can be used in an embodiment of the present invention (e.g., TEK RFID Cricket). In addition, any RFID personal digital assistant (PDA) adapter known in the art can be used to convert a PDA into a RFID reader 106 (e.g., TEK Protégé RFID Adapter). Also included in the exemplary system depicted in FIG. 1 is an employee identification card 108 that includes a RFID tag 110. The RFID tag 110 on the employee identification card 108 can be scanned by the RFID reader 106 to record the name of the employee who is checking the parking meter 102. The exemplary embodiment depicted in FIG. 1 also includes an external incident menu 400 with RFID tags 402 404 that can be scanned by the RFID reader 106 to associate an incident and status with a parking meter 102.

In the exemplary embodiment depicted in FIG. 1, a RFID reader 106 is connected to a host system 112 to perform functions that include uploading the data in the RFID reader 106 to an application running on the host system 112. As shown in FIG. 1, the RFID reader 106 may be connected to the host system 112 via a network 122 (e.g., using a docking station modem 120) or it may be directly attached. Communicating with the host system 112 is a user system 118. The user system 118 may communicate with the host system 112 via a network 122 or it may be directly attached. The user system 118 may be a personal computer or a host attached terminal. If the user system 118 is a personal computer, the processing and storage described herein may be shared by the user system 118 and the host system 112 in any manner known in the art. In an exemplary embodiment, the host system 112 is a personal computer (PC) and the user system 118 is a terminal attached to the PC. Also in this exemplary embodiment the PC and terminal are in the same geographic location. In an alternate exemplary embodiment, the host system is a PDA. In another exemplary embodiment, the host system 112 and the user system 118 are physically located in different geographic locations and the connection is made through a network 122 (e.g., local area network (LAN), intranet, Internet). In addition, the network 122 and network connection can be any kind known in the art including wireless networks and wireless connections.

The host system 112 can operate as an application server and execute maintenance monitoring applications that include system set-up functions (e.g. setting up the routes, initializing RFID tags), reporting functions and data transfer functions. If the RFID reader 106 is implemented using a PDA, the executing of applications described herein may be shared by the host system 112 and the PDA. In an exemplary embodiment, the host system 112 is a PC and the RFID reader 106 is attached to a jack that is attached to the COM port on the PC. In other exemplary embodiment, the host system 112 and the RFID reader 106 are physically located in different geographic locations and they are connected through a network 122 (e.g., local area network (LAN), intranet, Internet). In addition, the network 122 and network connection can be any kind known in the art including wireless networks and wireless connections. In an exemplary embodiment, the RFID reader 106 is implemented with a PDA and the PDA communicates with the host system 112 via the Internet and cellular communications.

Also depicted in FIG. 1 is a storage device 114 in communication with the host system 112. The storage device 114 may be implemented in a variety of devices for storing electronic information (e.g., a file transfer protocol server) and the data stored on the storage device 114 may be implemented using a variety of data formats (e.g., relational database). It is understood that the storage device 114 may be implemented using memory contained in the host system 112 or it may be a separate physical device. In an exemplary embodiment, the storage device is implemented using memory contained in a PC and Microsoft Access is used as the database to store data that includes employee data, route data, and maintenance data. In an exemplary embodiment, the host system 112 and the storage device 114 are located in the same geographic location and the communication is provided by a local attachment. In anther exemplary embodiment, the host system 112 and the storage device 114 are physically located in different geographic locations and a connection is made through a network 122 (e.g., local area network (LAN), intranet, Internet). In addition, the network 122 and network connection can be any kind known in the art including wireless networks and wireless connections.

The exemplary embodiment depicted in FIG. 1 includes a printer 116 connected to the host system 112. The printer 116 may be any printer known in the art and can be utilized to print out reports (e.g., missed meters, meters seen by employee). In an exemplary embodiment, the host system 112 and the printer 116 are located in the same geographic location and the communication is provided by local attachment. In another exemplary embodiment, the host system 112 and the printer 116 are physically located in different geographic locations and the connection is made through a network 122 (e.g., local area network (LAN), intranet, Internet). In addition, the network 122 and network connection can be any kind known in the art including wireless networks and wireless connections. In an alternate exemplary embodiment, the printer is attached to the user system 118.

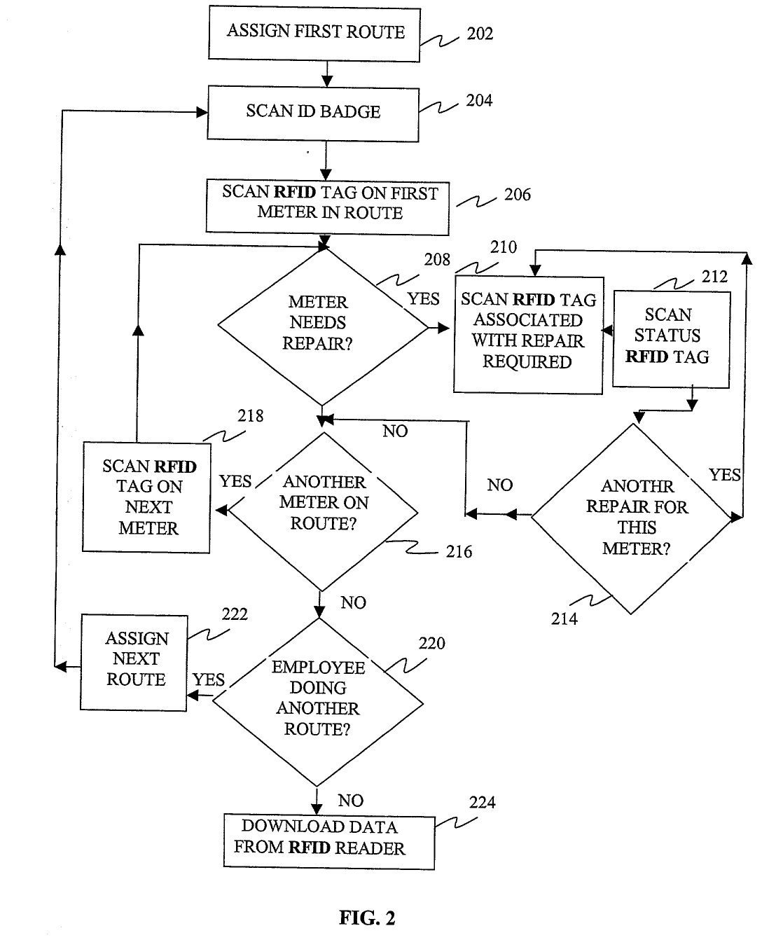

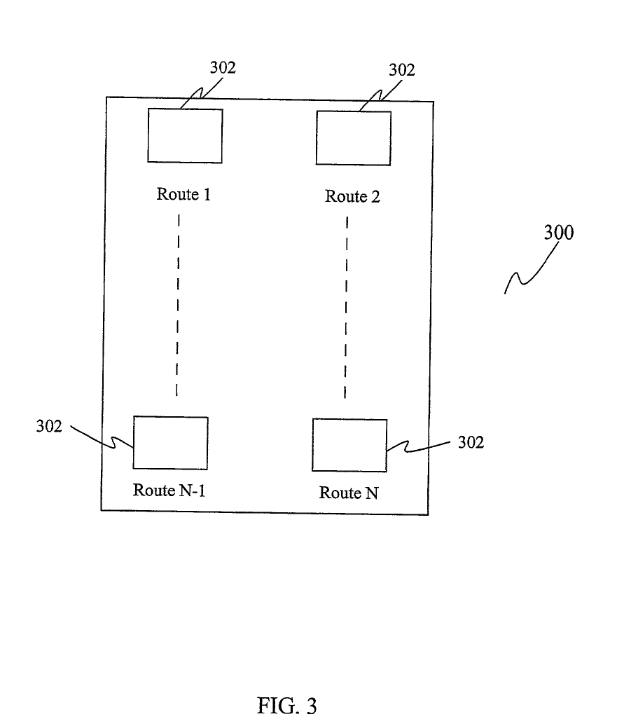

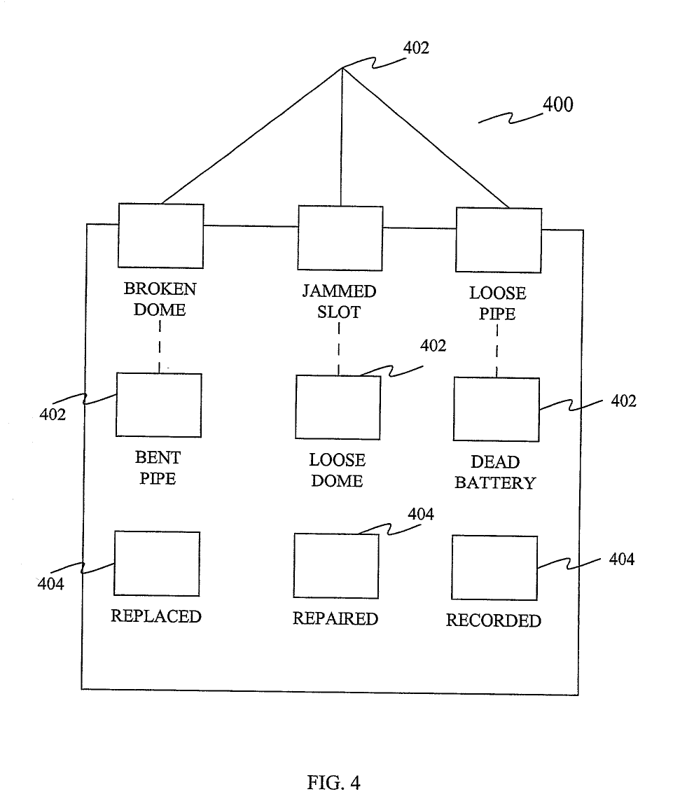

FIG. 2 is a block diagram of an exemplary process for collecting maintenance data for parking meters. Prior to executing the process depicted in FIG. 2, parking meters 102, incidents, routes and personnel have been assigned RFID tags by the maintenance monitoring application executing on the host system 112. At step 202, an employee scans an RFID tag on an external route menu 300, such as the one depicted in FIG. 3, that includes affixed or embedded RFID tags to assign the route that the employee will be reviewing. If the RFID reader 106 is implemented using a PDA then the employee may not have an external route menu 300 but instead use a menu on the PDA screen to select a route. During scanning, the RFID reader 106 records in its memory the unique serial number of the RFID tag along with a date/time stamp. At step 204, the RFID reader 106 is used to record the employee who is assigned to do maintenance on the route by performing a scan of the RFID tag 110 on the employee identification card 108. At step 206, the employee uses the RFID reader 106 to scan the RFID tag 104 on the first parking meter 102. During scanning, the RFID reader 106 records in its memory the unique serial number of the RFID tag 104 along with a date/time stamp. If the meter requires repair or replacement, as determined at step 208, then step 210 is performed and the employee scans an RFID tag associated with the incident from an external incident menu 400, such as the one depicted in FIG. 4. The external incident menu 400 includes affixed or embedded RIFD tags associated with various incidents (e.g., loose pipe, dead battery). Next, at step 212, the employee scans a second RFID tag on the external incident menu 400 to indicate the status of the repair. In an exemplary embodiment, status fields include: repaired, replaced and recorded for later action. During scanning, the RFID reader 106 records in its memory the unique serial number of the RFID tag along with a date/time stamp. If the RFID reader 106 is implemented using a PDA then the employee may not have an external incident menu 400 but instead use a menu on the PDA screen to select incident reporting data.

Next, step 214 is performed after recording an incident at steps 210 and 212. At step 214, a check is made to see if there are other repairs required for the parking meter 102. If additional repairs are required then step 210 is performed to record another incident. This loop, from steps 210 to 214 is performed until all repairs for a parking meter 102 have been recorded. At step 216, a check is made to see if there are other parking meters 102 on the route. If there are additional parking meters 102 on the route, step 218 is performed and the RFID tag 104 on the next parking meter is scanned by the RFID reader 106. During scanning, the RFID reader 106 records in its memory the unique serial number of the RFID tag along with a date/time stamp. Then, steps 208 through 218 are performed until there are no more parking meters 102 on the route. In an exemplary embodiment, a route contains between fifty and three hundred parking meters 102, but other route sizes are possible. At step 220, a check is made to see if there are other routes that this employee will be covering. If there is an additional route, step 222 is performed and an RFID tag on the external route menu 300 corresponding to the next route is scanned by the RFID reader 106. During scanning, the RFID reader 106 records in its memory the unique serial number of the RFID tag along with a date and time stamp. Then steps 204 through 222 are performed until there are no more routes assigned to the employee. At step 224, the data that has been gathered in the memory of the RFID reader 106 is downloaded to the host system 112.

FIG. 3 is an exemplary embodiment of an external route menu 300 that includes affixed or embedded RFID tags 302 associated with a plurality of routes. Each RFID tag 302 associated with a route includes a unique serial number that cannot be changed. FIG. 4 is an exemplary embodiment of an external incident menu 400 that includes affixed or embedded RFID tags 402 404 associated with incident and status fields. Incident fields describe the type of maintenance required and can include fields such as broken dome, jammed slot and loose pipe. Each incident field is associated with a RFID tag 402 that has a unique serial number. Status fields describe the status of the required maintenance and can include fields such as replaced, repaired, and recorded for later action. Each status field is associated with a RFID tag 404 that has a unique serial number. In an exemplary embodiment, the RFID reader 106 is used to scan the external route menu 300 and the external incident menu 400. In an alternate exemplary embodiment, when the RFID reader 106 is implemented using a PDA, an external menu is not utilized, but instead a menu containing the options is displayed on the PDA screen and an option is selected on the PDA screen.

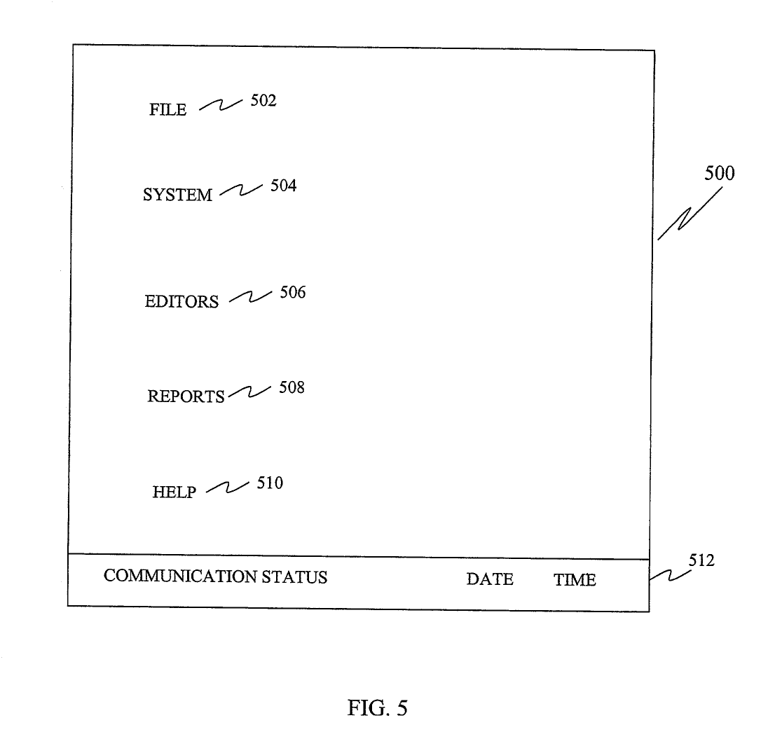

FIG. 5 is an exemplary maintenance monitoring application user interface that is displayed on the user system 118. In an exemplary embodiment, the maintenance monitoring application is executed on the host system 112. The options displayed include file 502, system 504, editors 506, reports 508 and help 510. At the bottom of the screen 500 is a communication status bar 512 that indicates the status of communication with external hardware (e.g. RFID reader 106). In an exemplary embodiment, if a port is initialized, the port is indicated, otherwise “NOCOM” is displayed. Also when a port is initialized, the communication message is animated to indicate activity on the port.

In an exemplary embodiment, functions from the file option 502 include import, view log, printer set-up, disable communication, exit supervisory mode and exit. Choosing the import function can invoke a file selection window for importing data in a format compatible with the maintenance monitoring application. Data imported includes data that has been downloaded from the memory of the RFID reader 106. Choosing the view log function causes the log file to be displayed. The maintenance application can be set up to log particular data and transactions and in an exemplary embodiment the log file is stored in an ASCII-text file so that it can be viewed by other applications (e.g., Windows Notepad, Word). The printer set-up function includes the ability to globally set the printer 116 properties that are used to display and print reports generated by the maintenance monitoring application. The disable communication function is used to pause or resume communication on the host system 112 port. The exit supervisory mode function is used to control access to particular portions of the maintenance monitoring application functions. In an exemplary embodiment, access to the editors 506, system functions 504, and reports 508 are password protected and may only be performed when in supervisory mode. Choosing the exit function causes the maintenance monitoring application program to be closed.

Functions accessible from the system option 504 depicted in FIG. 5 can include serial port set-up, data collection device (DCD) set-up, preferences, set supervisory password and purge old downloads. In an exemplary embodiment, serial port set-up allows a user to select from either a RFID reader 106 or a RFID reader 106 that is implemented using a PDA. The maintenance monitoring application will scan the ports on the host system 112 to find the selected type of RFID reader 106. The DCD setup function is used to configure a RFID reader 106 that is connected to the host system 112. Items such as time can be synchronized with the computer system and the memory in the RFID reader 106 can be cleared. Selecting the preferences function can allow a user to specify that a password is required on system start up and therefore only download of data from the RFID reader 106 can be performed until a valid password is entered. The set supervisory password function can be used to enter and reset the password. The purge old downloads function allows a user to delete old records from the download table. In an exemplary embodiment, a date can be specified and all data in the table before the date can be moved to a backup copy or deleted.

In an exemplary embodiment, such as the one depicted in FIG. 5, the editors option 506 can include functions to edit the meters, the routes, the incidents, the employees and the RFID tag serial numbers. Editing the meters includes the ability to create, edit, delete, print a listing of all parking meters 102 contained in the database or scan in a RFID tag (using the RFID reader 106) to associate with a particular parking meter 102. In an exemplary embodiment, meter data includes a meter identification number, one or more RFID tag serial numbers and a meter address that are stored in a relational database on the storage device 114. In an exemplary embodiment, the maintenance monitoring application can prevent deletion of a meter if the meter is assigned to a route. Editing the routes includes the ability to create, edit, delete, print a listing of all routes contained in the database or scan in a RFID tag (using the RFID reader 106) to associate with a particular route. In an exemplary embodiment, route data includes a route identification number, one or more RFID tag serial numbers and a number of meter identifiers associated with the route that are stored in a relational database on the storage device 114.

Editing the incidents, a function that is part of the editors option 506 in an exemplary embodiment, includes the ability to create, edit, delete, print a listing of all incident types 102 contained in the database or scan in a RFID tag (using the RFID reader 106) to associate with a particular type of incident. In an exemplary embodiment, incident data includes an incident description (e.g., broken dome, jammed slot) and one or more RFID tag serial numbers that are stored in a relational database on the storage device 114. The employee edit function that can be accessed through the editors 506 option on FIG. 5 includes the ability to create, edit, delete, print a listing of all employees contained in the database or scan in a RFID tag (using the RFID reader 106) to associate with a particular employee. In an exemplary embodiment, employee data includes an employee name, an employee identification number and one more RFID tag serial numbers that are stored in a relational database on the storage device 114.

The edit the RFID tag serial numbers function that can be accessed through the editors option 506 on FIG. 5 includes the ability to create, edit, delete, print a listing of all RFID tags contained in the database or scan (individually or in a batch) a new RFID tag (using the RFID reader 106). In an exemplary embodiment, RFID tag data includes a unique serial number, the type of data associated with the RFID tag (e.g., employee, meter, route, incident), and a description that are stored in a relational database on the storage device 114. The batch mode of scanning new RFID tags can be used when a large number of new RFID tags needed to be added.

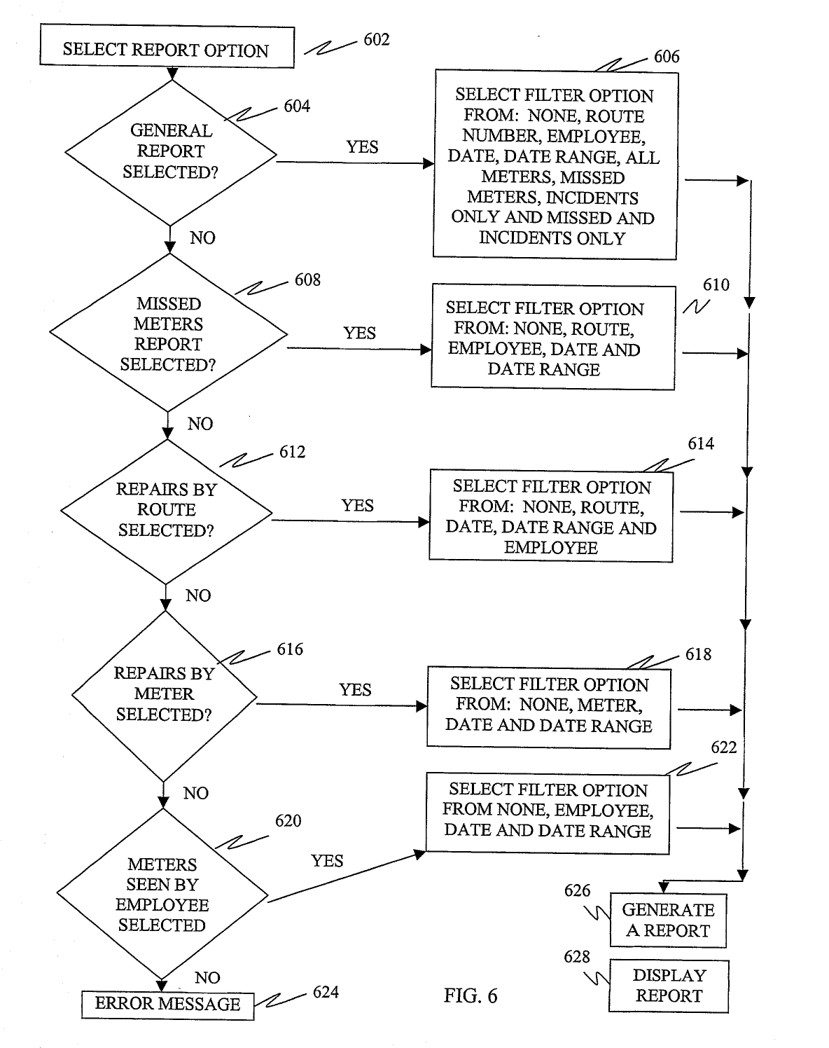

In an exemplary embodiment, functions from the report option 508 include the ability to create five types of reports: general query, missed meters by route, repairs by route, repairs by meter and meters seen by employee. The reporting process is described in reference to FIG. 6 below. The help option 510 depicted on the exemplary user interface in FIG. 5 provides the user with assistance in navigating through the maintenance monitoring application.

The functions described above in reference to FIG. 5 are examples of the kinds of options and functions that can be performed using an exemplary embodiment of the present invention. An alternate exemplary embodiment may include a subset of these functions with the addition of other functions. An alternate exemplary embodiment may also include a different ordering of these functions under either the same options depicted in FIG. 5 or under different options than those depicted in FIG. 5. Additionally, an exemplary user interface may include icons in the center of the screen for more frequently accessed functions and a tool bar across the top of the screen with all options and functions. If the RFID reader 106 is implemented using a PDA then the functions described in reference to FIG. 5, or a subset of these functions, may be executed and accessed via the PDA.

FIG. 6 is a block diagram of an exemplary process for performing the maintenance monitoring application reporting. The process described in FIG. 6 is invoked when a user selects the report option 508 from the user interface depicted in FIG. 5. At step 602, a report option is selected. If the report selected is the general report, as determined at step 604, then step 606 is performed. In an exemplary embodiment, the general report groups data in the report by the routes performed. At step 606, the user is prompted to select a filter option that will be used to determine what data from the database to include in the report. In an exemplary embodiment, the filter options can include: none, route number, employee, date and date range. Additional filters can include the ability to choose all meters, missed meters, incidents or both missed meters and incidents to be included in the report. A report created by choosing all meters for a route can be used to provide a route map for an employee who has been assigned to the route. Once the filter is chosen, processing continues at step 626.

If the report selected is the missed meters report, as determined at step 608, then step 610 is performed. In an exemplary embodiment, the missed meters report lists each route, the employee who performed it and how many meters were missed on the route. At step 610, the user is prompted to select a filter option that will be used to determine what data from the database to include in the report. In an exemplary embodiment, the filter options can include: none, route number, employee, date and date range. Once the filter is chosen, processing continues at step 626. If the report selected is the repairs by route report, as determined at step 612, then step 614 is performed. In an exemplary embodiment, the repairs by route report groups data by route and within each route by repair required. At step 614, the user is prompted to select a filter option that will be used to determine what data from the database to include in the report. In an exemplary embodiment, the filter options can include: none, route number, employee, date and date range. Once the filter is chosen, processing continues at step 626.

If the report selected is the repairs by meter report, as determined at step 616, then step 618 is performed. In an exemplary embodiment, the repairs by meter report groups data by meter and within each meter by repair required in date order. At step 618, the user is prompted to select a filter option that will be used to determine what data from the database to include in the report. In an exemplary embodiment, the filter options can include: none, meter number, date and date range. Once the filter is chosen, processing continues at step 626. If the report selected is the meters seen by employee report, as determined at step 620, then step 622 is performed. In an exemplary embodiment, the meters seen by employee report groups data by employee and within each employee by repairs required. At step 622, the user is prompted to select a filter option that will be used to determine what data from the database to include in the report. In an exemplary embodiment, the filter options can include: none, employee, date and date range. Once the filter is chosen, processing continues at step 626. If a user does not select one of the valid reporting options an error message is generated at step 624. At step 626 the requested report is generated using data contained in the database stored on the storage device 114. At step 628, the report is displayed on the user system 118 or printed on the printer 116.

An embodiment of the present invention utilizes RFID tags 104 that include a unique serial number that cannot be changed. This can result in increased security of the information as to the identity of the parking meter 102 and can prevent the public from tampering with these tags by use of an external device. In addition, because the RFID reader 106 is used to scan the RFID tags and no data entry is required, the monitoring process may be able to be performed more quickly and without data entry errors. The ability to upload the data to a host system 112 and manipulate it to create a variety of reports can also lead to increased tracking capabilities and may lead to faster turn-around in fixing the meters and in pinpointing problem routes.

Although the preceding embodiments are discussed with respect to parking meters, it is understood that the monitoring methodology and system described herein is not limited to parking meters, but may be utilized in other applications including vending machine applications.

As described above, the embodiments of the invention may be embodied in the form of computer-implemented processes and apparatuses for practicing those processes. Embodiments of the invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. An embodiment of the present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. A method for monitoring parking meters, said method comprising:
selecting a route, wherein said route includes a parking meter identifier;
selecting an employee to monitor said route;
scanning a meter RFID tag affixed to a parking meter wherein:
said parking meter corresponds to said parking meter identifier;
said scanning a meter RFID is performed using a RFID reader;
said RFID reader includes memory; and
said meter RFID tag includes a first unique serial number;
storing said first unique serial number and a first date/time stamp in said memory in response to said scanning a meter RFID;
selecting an incident code in response to determining that said parking meter needs repair;
selecting a status code in response to said selecting an incident code and to a current status of said parking meter; and
transmitting the contents of said memory to a host system.

2. The method of claim 1 wherein said selecting a route includes:
scanning a route RFID tag affixed to an external menu, wherein said scanning a route RFID tag is performed using said RFID reader and wherein said route RFID tag includes a second unique serial number; and
storing said second unique serial number and a second date/time stamp in said memory in response to said scanning a route RFID tag.

3. The method of claim 1 wherein said selecting a route includes:
selecting a route number from a computer screen on said RFID reader, wherein said route number is associated with a second unique serial number;
storing said second unique serial number and a second date/time stamp in said memory in response to said selecting a route number.

4. The method of claim 1 wherein said selecting an employee to monitor said route includes:
scanning an employee RFID tag affixed to an external menu, wherein said scanning an employee RFID tag is performed using said RFID reader and wherein said employee RFID tag includes a second unique serial number; and
storing said second unique serial number and a second date/time stamp in said memory in response to said scanning an employee RFID tag.

5. The method of claim 1 wherein said selecting an employee to monitor said route includes:
selecting an employee from a computer screen on said RFID reader, wherein said employee is associated with a second unique serial number;
storing said second unique serial number and a second date/time stamp in said memory in response to said selecting an employee.

6. The method of claim 1 wherein said selecting an incident code includes:
scanning an incident RFID tag affixed to an external menu, wherein said scanning an incident RFID tag is performed using said RFID reader and wherein said incident RFID tag includes a second unique serial number; and
storing said second unique serial number and a second date/time stamp in said memory in response to said scanning an incident RFID tag.

7. The method of claim 1 wherein said selecting an incident code includes:
selecting an incident from a computer screen on said RFID reader, wherein said incident is associated with a second unique serial number;
storing said second unique serial number and a second date/time stamp in said memory in response to said selecting an incident.

8. The method of claim 1 wherein said selecting a status code includes:
scanning a status code RFID tag affixed to an external menu, wherein said scanning a status code RFID tag is performed using said RFID reader and wherein said status code RFID tag includes a second unique serial number; and
storing said second unique serial number and a second date/time stamp in said memory in response to said scanning a status code RFID tag.

9. The method of claim 1 wherein said selecting a status code includes:
selecting a status code from a computer screen on said RFID reader, wherein said status code is associated with a second unique serial number;
storing said second unique serial number and a second date/time stamp in said memory in response to said selecting a status code.

10. The method of claim 1 further comprising:
receiving the contents of said memory at said host system;
storing the contents of said memory in a database in response to said receiving.

11. The method of claim 10 further comprising:
displaying reporting options;
receiving a user selection corresponding to said reporting options;
creating a report in response to said user selection and to said database; and
displaying said report.

12. The method of claim 11 further comprising printing said report.

13. The method of claim 11 further comprising transmitting said report.

14. The method of claim 11 wherein said reporting options include:
a general report;
a missed meters report;
a repairs by route report;
a repairs by meter report; and
a meters seen by employee report.

15. The method of claim 10 further comprising:
displaying maintenance monitoring options;
receiving a user selection corresponding to said maintenance monitoring options; and
performing an activity associated with said user selection in response to receiving said user selection.

16. The method of claim 15 wherein said maintenance monitoring options include file options, system options, editors options, reports options and help options.

17. The method of claim 16 wherein said file options include import, view log, printer set-up, disable communication, exit supervisory mode and exit.

18. The method of claim 16 wherein said system options include serial port set-up, DCD set-up, preferences, set supervisory password and purge old downloads.

19. The method of claim 16 wherein said editors options include edit meters, edit routes, edit incidents, edit employees and edit serial numbers.

20. The method of claim 16 wherein said reports options include a general report, a missed meters report, a repairs by route report, a repairs by meter report and a meters seen by employee report.

21. A method for monitoring parking meters, said method comprising:
displaying maintenance monitoring options;
receiving a user selection corresponding to said maintenance monitoring options; and
performing an activity associated with said user selection in response to receiving said user selection.

22. A system for monitoring parking meters, said system comprising:
a meter RFID tag affixed to a parking meter wherein said meter RFID tag includes a unique serial number;
a RFID reader for scanning said meter RFID tag, wherein said RFID reader includes memory for storing said unique serial number in response to said scanning and a date/time stamp associated with said scanning; and
a communication link for transmitting the contents of said memory to a host system.

23. The system of claim 22 wherein said RFID reader includes a PDA and a PDA adaptor.

24. The system of claim 23 wherein said PDA includes said memory.

25. The system of claim 22 wherein said communication link is a direct connection through a serial port.

26. The system of claim 22 wherein said communication link is a network.

27. The system of claim 26 wherein said network is an intranet.

28. The system of claim 26 wherein said network is a LAN.

29. The system of claim 26 wherein said network is the Internet.

30. The system of claim 22 further comprising:
a host system for receiving the contents of said memory, wherein said host system includes a maintenance monitoring application;
a storage device in communication with said host system, wherein said data storage device stores the contents of said memory in response to said receiving; and
a user system in communication with said host system, wherein said user system includes a user interface to said maintenance monitoring system application and wherein said maintenance monitoring application implements the method comprising:
displaying maintenance monitoring options;
receiving a user selection corresponding to said maintenance monitoring options; and
performing an activity associated with said user selection in response to receiving said user selection and to a database located on said storage device.

31. The system of claim 30 wherein said maintenance monitoring application includes instructions to implement a method further comprising:
receiving the contents of said memory; and
storing the contents of said memory in said database.

32. The system of claim 30 wherein said host system is a PC.

33. The system of claim 30 wherein said host system is a PDA.

34. The system of claim 30 wherein said database is a relational database.

35. The system of claim 30 wherein said user system is a host attached terminal.

36. The system of claim 30 wherein said user system is a PDA.

37. The system of claim 30 wherein said storage device is in communication with said host system via a network.

38. The system of claim 37 wherein said network is the Internet.

39. The system of claim 30 wherein said user system is in communication with said host system via a network.

40. The system of claim 39 wherein said network is the Internet.

41. A storage medium encoded with machine-readable computer program code for monitoring parking meters, the storage medium including instructions for causing a computer to implement a method comprising:
displaying maintenance monitoring options;
receiving a user selection corresponding to said maintenance monitoring options; and
performing an activity associated with said user selection in response to receiving said user selection and to a database.

42. The storage medium of claim 41 further comprising instructions for causing a computer to implement:
receiving a file, wherein said file includes a unique serial number and a corresponding date/time stamp; and
storing said file in said database.
